(19) United States
(12) Patent Application Publication
(10) Pub. No.: US 2020/0112013 A1
(43) Pub. Date: Apr. 9, 2020

(54) Contact Having a Composite Material

(71) Applicant: Thomas Krämer, St. Julian's (MT)

(72) Inventor: Thomas Krämer, St. Julian's (MT)

(73) Assignee: E-Seven Systems Technology Management Ltd, Valletta (MT)

(21) Appl. No.: 16/604,949

(22) PCT Filed: Apr. 12, 2018
(86) PCT No.: PCT/EP2018/059465

§ 371 Date: Oct. 11, 2019

(30) Foreign Application Priority Data
Apr. 12, 2017 (DE) 10 2017 107 928.9

(51) Int. Cl. H01M 2/20; H01R 4/58

(52) U.S. Cl. CPC H01M 2/206; H01R 4/58

(57) ABSTRACT

Embodiments of the disclosure relate to a contact with a composite material containing an elastic material and a metal material which is introduced into the elastic material to conduct an electric current of a battery cell. The metal material forms a metal body with a cohesive geometric structure which extends through the composite material, such that an electric and a thermal current can be conducted through the composite material via the metal body. Embodiments of the disclosure also relate to an electrically conductive connecting plate and a battery.

The invention relates to a contact with a composite material containing an elastic polymeric material and a metal material which is introduced into the polymeric material to conduct an electric current of a battery cell.

Contacts made of a composite material containing an elastic polymeric material and a metal material are previously known from the prior art. The publication WO 2014/016393 A1 discloses an energy storage device for a vehicle which is equipped with correspondingly formed contacts. In the case of the disclosed energy storage device, an energy storage system such as a battery cell, for example, is connected to a circuit board via a plurality of elastic contacts. The contacts consist of an elastomer into which metal particles are introduced. The contacts establish an elastic effect between the energy storage system and the circuit board. This allows electric contacting between the battery cell and the circuit board. The contacts are also electrically conductive due to the metal particles introduced therein.

However, it has been found that no or only few fully highly conductive tracks form in such a composite material if normal operating voltages are applied to the contacts. As a result, a desired low electric resistance is not set between the circuit board and the energy storage system. Therefore, the object of the present invention is to provide an elastic contact which has a very high electric conductivity.

The object is achieved by a contact of the generic type described at the outset, wherein according to the invention the metal material forms a metal body with a cohesive geometric structure which extends through the composite material such that an electric and a thermal current can be conducted through the composite material via the metal body. Since the metal body has a cohesive geometric structure, highly conductive tracks are present in the composite material for conducting an electric current. Furthermore, a thermal current can also be conducted via the metal body since metals have an exceptionally good thermal conductivity. Nevertheless, according to the invention, the thermal current can be conducted by the polymeric material.

The contact is elastic due to the elastic material used inside the composite material. In this case, the elastic material fills intermediate spaces, gaps, holes or other imperfections of the metal structure located in the composite material. In order to achieve a particularly good elasticity of the contact, the composite material should have less than 20 vol. % metal material. The composite material preferably has less than 15 vol. %. Particularly preferably, it has less than 10 vol. % metal material.

The elastic material is preferably formed such that it can readopt its original length due to a length change of 20% or more as a result of a compression. According to the invention, the elastic material should have an elasticity modulus of less than or equal to 0.5 N/m², preferably less than or equal to 0.1 N/m² and quite particularly preferably less than or equal to 0.05 N/m².

The contact being formed to conduct an electric current of a battery cell is understood to mean that the contact can conduct a charge and/or discharge current of a battery cell. The current is conducted permanently by the contact. The charge or discharge current is in particular a current which typically occurs in battery cells (for example an energy cell or a power cell) of a battery of a mobile or stationary energy storage system, for example for a home or industrial storage system or for a motor vehicle, which is driven with electric power.

Thus, the contact is formed such that it can conduct a (recommended) charge current permanently received and/or discharge current permanently emitted by the battery without damage. For example, the contact is formed such that it can also conduct a maximum charge current received and/or maximum discharge current emitted by the battery cell permanently or at least briefly.

The contact is formed and suitable for this purpose due to the specific electrical properties of the material used, in particular in combination with the geometry used (in particular the cross-sectional geometry). In particular, a sufficiently low transition resistance or contact resistance for this purpose is achieved. In this case, sufficient heat dissipation (in particular into the electrically conductive connecting plate) can also be achieved from heat resulting during operation.

For example, a mentioned permanent charge current is at least 500 mA, preferably at least 1000 mA. Exemplary permanent charge currents are 1010 mA, 1020 mA, 1700 mA, 1675 mA or in particular in the case of power cells also 2000 mA or 3000 mA. For example, a mentioned maximum charge current is at least 1500 mA, preferably at least 2000 mA. Exemplary maximum charge currents are 2000 mA, 3000 mA, 3400 mA, 4000 mA, 5000 mA or 6000 mA.

For example, a mentioned permanent discharge current is at least 500 mA, preferably at least 1000 mA. Examples of permanent discharge currents are 670 mA or 680 mA. For example, a mentioned maximum discharge current is at least 5000 mA, preferably at least 8000 mA. Exemplary maximum discharge currents are 8000 mA, 10000 mA, 13000 mA or in particular in the case of power cells also 15000 mA, 30000 mA or 35000 mA.

As mentioned, the cross-sectional surface of the contact is in particular dimensioned such that a sufficient low transition resistance or contact resistance and therefore a current flow, as described, and sufficient heat dissipation (with respect to the material used in each case) is achieved. For example, the cross-sectional surface of the contact (as far as provided in particular in the region of at least one of the contacting regions or one of the contact elements) is at least in sections, preferably continuously at least 15 mm², preferably at least 35 mm², further preferably at least 75 mm² and further preferably at least 175 mm². In the case of a substantially round cross-sectional geometry of the contact, the diameter of the contact is therefore at least 5 mm, preferably at least 7 mm, further preferably at least 10 mm, further preferably at least 15 mm.

The metal body preferably forms an uninterrupted electric conductor. It is advantageous if the metal body consists of copper or of silver. Both copper and silver have an exceptionally good electric and thermal conductivity. However, silver or copper do not necessarily have to be used. The use of other metals is also possible. According to the invention, a silver alloy, a copper alloy or another metal alloy can be used.

The elastic material can, according to the invention, be a natural rubber or a synthetic rubber. Rubbers are materials which have very good elastic properties and good durability which means in particular a long lifetime. Rubber can be brought to an increased temperature, at which it is liquid, when producing the contact. The metal body can now be introduced into the rubber. Then, the rubber hardens and forms an electrically and thermally conductive contact in the composite with the metal body.

The elastic material is preferably a nitrile butadiene rubber, a hydrated nitrile rubber, an ethylene propylene diene rubber, a silicone rubber, a fluorine silicone rubber, a perfluorine rubber, a chlorine rubber, a chlorsulphonated polyethylene rubber, a polyester urethane rubber or a butyl rubber. The mentioned materials have, with respect to their elasticity modulus, their hardness, their flammability, their ageing resistance and further parameters, different properties and can be selected taking into account the purpose of use of the contact according to the invention. Additives can be added to the mentioned rubbers to improve their elasticity.

According to a particular embodiment of the invention, the elastic material is electrically conductive. More recently, various polymeric materials were developed which are electrically conductive. A composite material, which contains both a metal body and electrically conductive elastic material, has a particularly high electric conductivity. The use of such an elastic material is therefore desired. The electrically conductive elastic material does not necessarily have to be a polymer; the use of other elastic, electrically conductive materials is also possible according to the invention. According to the invention, the use of elastic materials is also possible which are only electrically conductive from a certain limit temperature or from a certain breakdown voltage.

According to the invention, the elastic material can be formed from doped polyacetylene, from polypyrrole, from polyaniline, from polythiophene or from poly-3, 4-ethylenedioxythiophene. Additives can be added to these materials to improve their elasticity. The mentioned materials have, with respect to their electric conductivity, their elasticity modulus, their hardness, their flammability, their ageing resistance and further parameters, different properties and can be selected taking into account the purpose of use of the contact according to the invention.

It is advantageous when the metal structure on surfaces of the elastic material is exposed in at least two contacting regions. If the metal body is exposed in the contacting regions, a current can be conducted directly into the metal body via a first contacting region of the contact without it having to penetrate the elastic material. The current is conducted through the contact via the metal body and can be led out of the contact in the region of a second contacting region. The metal body can be exposed in the contacting regions in each case at multiple points. According to possible embodiments of the invention, sections of the metal body can emerge from the metal body in the contacting regions. The two contacting regions are preferably arranged on opposing sides of the contact. The contact can consequently be electrically contacted on two opposing sides. In the case of the intended use, the contact is normally elastically deformed such that a distance is reduced between the two contacting regions owing to the elastic deformation.

The contact preferably has two electrodes which are designated below as contact elements and can in particular be contacting surfaces. The contact elements are connected in an electrically and thermally conductive manner on opposing sides of the composite material to the composite material. It is also possible according to the invention that a contact element is arranged only on one side of the composite material. The contact elements can, according to the invention, be connected in an electrically and thermally conductive manner to the contacting regions of the composite material. The contact elements can be metal plates. The contact elements provide a well-defined contact resistance to the composite material.

The metal body is preferably a metal fleece, a metal mesh or a metal foam. The metal fleece is a metal body which consists of disorderly arranged metal fibres and/or other fine metal structures. The metal mesh is a metal body which consists of metal fibres interwoven together or other fine metal structures. The metal foam is a metal body which has a number of cavities. The metal foam has a sponge-like structure.

It is also possible for the metal body to consist of directionally arranged metal fibres. Unlike the metal fleece, individual fibres are in this case not arranged randomly, but in a directional manner. This material is therefore also direction dependent with respect to its mechanical properties. The material can for example consist of a multitude of metal fibres which are aligned parallel to one another.

The metal foam is elastic and can therefore contribute to the elasticity of the composite material. A metal body, which is formed as a metal fleece or as a metal mesh, can, according to particular embodiments, also have elastic properties. The person skilled in the art can produce metal fleeces, metal meshes and metal bodies from directionally arranged metal fibres owing to his knowledge in such a manner that they are elastic. The elasticity of the metal fleeces, metal meshes or metal bodies results in an advantageous manner substantially from the geometric arrangement of the individual metal fibres to one another.

The metal body can, according to the invention, also have a grid structure or a lattice structure. A metal body, which has a grid structure or a lattice structure, consists of a number of metal wires which are connected to one another at nodal points. A metal body made of a grid structure or of a lattice structure can also be equipped such that the metal body is elastically deformable in particular owing to the elastic properties of the individual metal wires and therefore contributes to the elasticity of the composite material.

The invention also relates to an electrically conductive connecting plate which has a contact, as described.

The invention also relates to a battery with at least one battery cell, an electrically conductive connecting plate and a contact to connect a battery pole of the battery cell to the circuit board. The contact is a contact according to the invention as described above. The battery preferably contains a number of battery cells which are connected to a connecting plate in an electrically and thermally conductive manner via a contact according to the invention. The connecting plate is preferably a circuit board. According to the invention, the connecting plate is, however, also a metal plate. The connecting plate is particularly preferably a copper plate.

The elastic material of the composite material preferably has an elasticity modulus which is set such that the connecting plate is not damaged when contacting the battery cells through a force effect of the battery poles of the battery cells on the connecting plate. The elasticity modulus is preferably also set such that a battery cell can be clamped on the contacts between two connecting plates of a battery spaced apart from one another, which are provided with contacts according to the invention, and can be held by the contacts between the connecting plates, advantageously also in the case of forces acting for example due to vibrations of the battery on the battery cells.

According to a further embodiment of the invention, the contact is applied on the connecting plate. The contact can be applied on the connecting plate on regions which are provided in order to be contacted with battery cells of the battery in an electrically and thermally conductive manner.

It is also possible according to the invention for the contact to be applied on a circuit board of the battery. The contact can be covered on the surface facing the circuit board by a contact element. If a pressure is exerted on the contact element by a battery pole of a battery cell, the contact can be elastically deformed and a low-impedance contact transfer ensured between the battery cell and the circuit board.

Further advantageous embodiments of the invention are represented in the drawings, wherein:

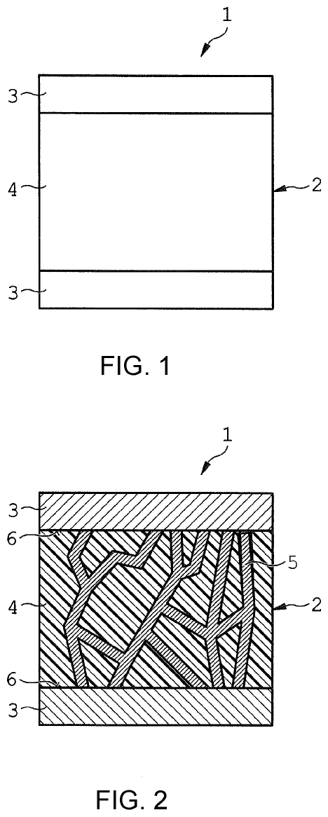

FIG. 1 shows a contact according to the invention,

FIG. 2 shows the contact from FIG. 1 in a sectional view,

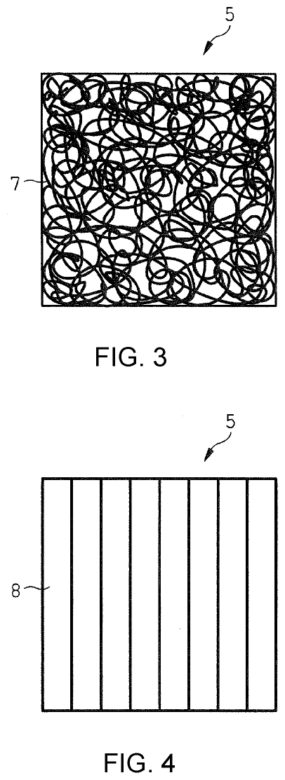

FIG. 3 shows a metal body made of a metal foam,

FIG. 4 shows a metal body made of directionally arranged metal fibres,

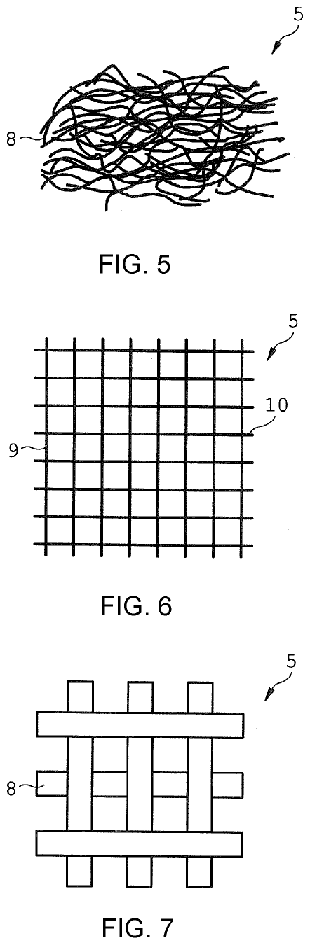

FIG. 5 shows a metal body made of a metal fleece,

FIG. 6 shows a metal body with a lattice structure,

FIG. 7 shows a metal body made of a metal mesh,

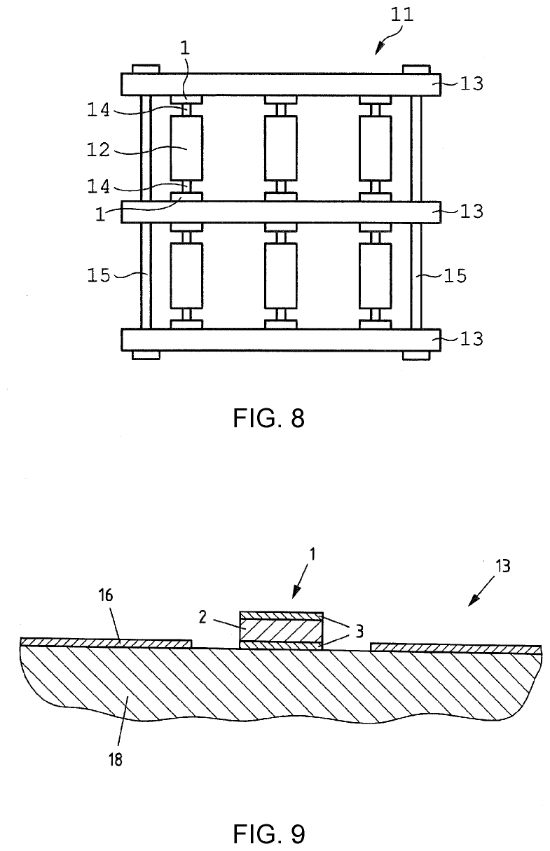

FIG. 8 shows a battery according to the invention,

FIG. 9 shows a connecting plate with a contact integrated therein, and

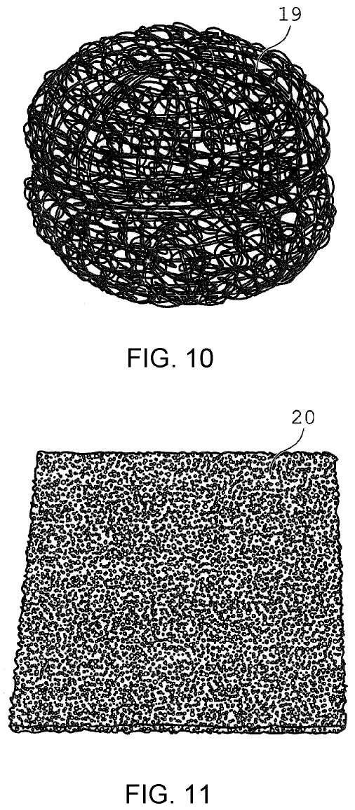

FIGS. 10 to 15 show the structure of different starting materials made of metal for a metal body.

FIG. 1 shows a contact 1 according to the invention. The contact has a composite material 2 and two contact elements 3 which are arranged on opposing sides of the composite material 2. The contact elements 3 consist of metal and are connected in a thermally and electrically conductive manner to the composite material 2. The composite material 2 has a natural rubber as the elastic material 4. A metal body, not shown, is embedded into the elastic material. The contact 1 is therefore elastic and also electrically and thermally conductive.

FIG. 2 shows the contact 1 according to the invention from FIG. 1 in a sectional view. A metal body 5, which has a cohesive geometric structure, is embedded into the elastic material 4 of the composite material 2. The cohesive geometric structure is in the present case a grid structure. An electric current and a thermal current can be conducted along the metal body 5 through the composite material 2. The metal body 5 is exposed in the contacting regions 6 of the composite material 2 and is connected directly to the contact elements 3 in an electrically and thermally conductive manner.

FIG. 3 shows a metal body 5 made of a metal foam. This is a particular embodiment of the metal body 5. The metal foam 5 has a structure with a number of cavities 7. Such a metal body has particularly good elastic properties.

FIG. 4 shows a metal body 5 made of directionally arranged metal fibres 8. The directionally arranged metal fibres 8 are arranged substantially parallel to one another and rest against one another. The metal body 5 maintains its structure as a result of it being introduced into the elastic material 4.

FIG. 5 shows a metal body 5 made of a metal fleece. The metal fleece has a plurality of metal fibres 8 which are not directionally arranged, but rather rest against one another in a loose bond. The metal fleece shown is elastic and can therefore contribute to the elasticity of the composite material.

FIG. 6 shows a metal body 5 with a lattice structure. Individual metal wires 9 of the lattice structure are connected to one another in nodal points 10. The lattice structure shown has elastic properties.

FIG. 7 shows a metal body 5 made of a metal mesh. The metal fibres 8 of the metal mesh are interwoven together which means that they run under and over one another in an orderly manner.

FIG. 8 shows a battery 11 according to the invention. The battery 11 has a plurality of battery cells 12 which are connected to one another in an electrically and thermally conductive manner via a plurality of connecting plates 13. The connecting plates 13 shown are copper plates. Each battery cell 12 has battery poles 14 at opposing ends. The battery poles 14 of the battery cells 12 are connected to the connecting plates 13 in an electrically and thermally conductive manner via contacts 1 according to the invention. Tension elements 15 are guided through the connecting plates 13 whereby the individual elements of the battery 11 are compressed together. It is ensured by the contacts 1 that no damage results to the battery cells 12 or the connecting plates 13 through the compression and that in each case a well-defined contact resistance is provided between the battery poles 14 and the connecting plates 13.

FIG. 9 shows the connecting plate 13 with a contact 1 arranged thereon. The connecting plate 13 is for example a composite plate. The connecting plate 13 has a non electrically conductive layer 16. The contact 1 is arranged on an electrically conductive layer 18. The contact 1 comprises the composite material 2 according to the invention. The contact 1 also comprises two opposingly arranged contact elements 3. The composite material 2 is connected to the conductive layer 18 of the connecting plate 13 in an electrically and thermally conductive manner via the contact element 3 facing the connecting plate.

FIG. 10 shows the structure of a metal structure 19 with a sponge-like structure.

FIG. 11 shows a structure of a metal element 20 made of a foamed metal.

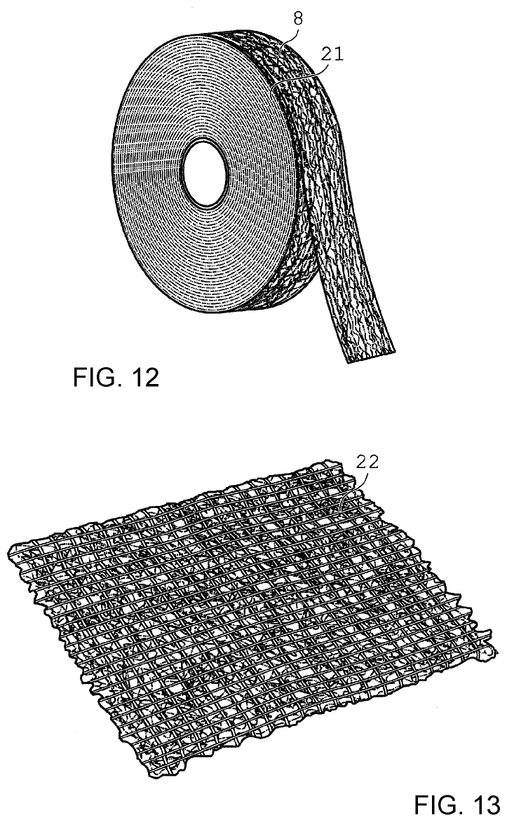

FIG. 12 shows the structure of a metal fibre element 21 made of metal fibres 8.

FIG. 13 shows the structure of a metal fabric 22.

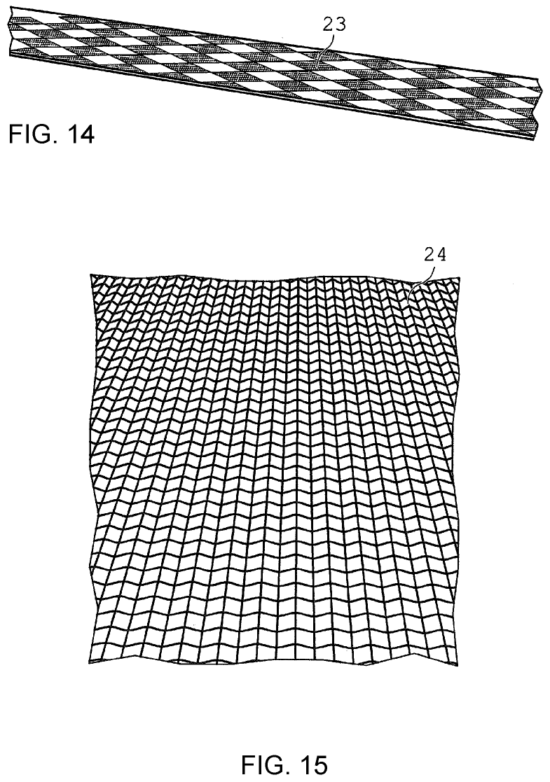

FIG. 14 shows the structure of a metal mesh 23.

FIG. 15 shows the structure of a metal lattice 24.

### LIST OF REFERENCE NUMERALS

1. Contact
2. Composite material
3. Contact element
4. Elastic material
5. Metal body
6. Contacting region
7. Cavity
8. Metal fibre
9. Metal wire
10. Nodal point
11. Battery
12. Battery cell
13. Connecting plate
14. Battery pole
15. Tension elements
16. Non-conductive layer
18. Conductive layer
19. Metal structure
20. Metal element
21. Metal fibre element
22. Metal fabric
23. Metal mesh
24. Metal lattice

1-17. (canceled)

18. A contact with a composite material containing an elastic material and a metal material which is introduced into the elastic material, to conduct an electric current of a battery cell, wherein the metal material forms a metal body with a cohesive geometric structure which extends through the composite material such that an electric and a thermal current can be conducted through the composite material via the metal body, wherein the metal body is a metal fleece, is a metal mesh, consists of directionally arranged metal fibres, or has a grid structure or a lattice structure.

19. The contact according to claim 18, wherein the metal body forms an uninterrupted electric conductor.

20. The contact according to claim 18, wherein the metal body consists of a metal alloy, for example a copper or silver alloy.

21. The contact according to claim 19, wherein the metal body consists of copper or silver.

22. The contact according to claim 18, wherein the elastic material is a natural rubber or a synthetic rubber.

23. The contact according to claim 22, wherein the elastic material is a nitrile butadiene rubber, a hydrated nitrile rubber, an ethylene propylene diene rubber, a silicone rubber, a fluorine silicone rubber, a perfluorine rubber, a chlorine rubber, a chlorsulphonated polyethylene rubber, a polyester urethane rubber or a butyl rubber.

24. The contact according to claim 18, wherein the elastic material is electrically conductive.

25. The contact according to claim 24, wherein the elastic material is formed from doped polyacetylene, from polypyrrole, from polyaniline, from polythiophene or from poly-3,4-ethylenedioxythiophene.

26. The contact according to claim 18, wherein the metal body is exposed on surfaces of the elastic material in at least two contacting regions.

27. The contact according to claim 25, wherein the two contacting regions are located on opposing sides of the contact.

28. The contact according to claim 18, wherein the contact has two contact elements which are connected to the composite material in an electrically and thermally conductive manner on opposing sides of the composite material.

29. The contact according to claim 18, wherein the contact can conduct current of at least 1000 mA, preferably at least 5000 mA, more preferably at least 8000 mA, in particular permanently.

30. The contact according to claim 18, wherein the cross-sectional surface of the contact is at least in sections, preferably continuously, at least 15 mm², preferably at least 35 mm², further preferably at least 75 mm².

31. An electrically conductive connecting plate, wherein the electrically conductive connecting plate has a contact according to claim 18.

32. A battery with at least one battery cell, an electrically conductive connecting plate and a contact for connecting a battery pole of the battery cell to the connecting plate, wherein the contact is formed as a contact according to claim 18.
